(19) United States
(12) Patent Application Publication
(10) Pub. No.: US 2026/0127513 A1
(43) Pub. Date: May 7, 2026

(54) Air Travel Reservation Inventory Generation

(71) Applicant: NVRLND, LLC, New York, NY (US)

(72) Inventor: Edna Catalina Ruiz Trevino, New York, NY (US)

(21) Appl. No.: 19/437,957

(22) Filed: Dec. 31, 2025

Related U.S. Application Data
(63) Continuation-in-part of application No. 19/053,326, filed on Feb. 13, 2025.
Application No. 19/053,326 is a continuation-in-part of application No. 18/405,663, filed on Jan. 5, 2024, now abandoned.

(51) Int. Cl. G06Q 10/02

(52) U.S. Cl. CPC G06Q 10/0283

(57) ABSTRACT

An air travel reservation system including a digital platform system is disclosed that generates new inventory of air travel reservations. The digital platform system is operably connected to a global distribution system and a computer. The digital platform system includes a registered user memory bank, a registered user air travel reservation memory bank, a registered user air travel reservation cancellation queue storage register, and a new generated air travel itinerary inventory storage register. The air travel reservation memory bank is operatively connected to the registered user memory bank and the global distribution system. The reservation memory bank includes a booked air travel reservation register and a booking air travel itinerary register. The cancellation queue storage register is operably connected to the air travel reservation memory bank and the global distribution system. The cancellation queue storage register is configured to transfer reservation information to the new generated air travel itinerary inventory storage register. The digital platform system includes an itinerary-match register operatively connected to the air travel reservation memory bank and the air travel reservation cancellation queue storage register.

### CROSS REFERENCE TO RELATED APPLICATIONS

The present patent application is a continuation-in-part (“CIP”) of U.S. application Ser. No. 19/053,326 (filed Feb. 13, 2025), which is a CIP of U.S. application Ser. No. 18/405,663 (filed Jan. 5, 2024), which is a CIP of U.S. application Ser. No. 16/431,820 (filed Jun. 5, 2019), which is based upon U.S. Provisional Application Ser. No. 62/680,686 (filed Jun. 5, 2018), all of which are hereby incorporated by reference in their entirety for priority purposes pursuant to Title 35, United States Code, Section 120.

### FIELD

The present subject matter is directed, in general, to an air travel reservation (ATR) system and, is more particularly, directed to an ATR system and process in which the system provides new generated air travel inventory for potential purchase. It does not “exchange”, “transfer”, or “resell” ATRs, which is strictly forbidden. Laws, restrictions, regulations, and other policies forbid air travelers and others to transfer or resell ATRs for safety and other reasons.

### BACKGROUND

US 2008/0027765 to Gunn et al. discloses a computer-implemented method of vending air-travel services and determining published fares. Each fare is associated with a respective one of several different booking classes. The published fares are applicable to the purchase of air travel at an associated service level. The method also determines a plurality of associated fares. Each of the fares is associated with an equivalent booking class, namely, one of the several different booking classes. Derived fares are applicable to the purchase of air travel at a certain service level. A derived fare for an equivalent booking class is one of the different booking classes, computed from the published fare associated with said certain one of the different booking classes, by applying a common price differential across multiple root booking classes. This method includes offering air travel sales at multiple price points, including at least one of the published fares and at one of the derived fares. The equivalent booking class associated with the first one of the derived fares corresponds to a different booking class associated with the first one of the published fares. US 2008/0162196 to Espinosa et al. is directed to a process and system for identifying and consolidating information and maintaining it related to a traveler's unused airline ticket in order to assign it value that the same traveler may then attempt to apply to other travel (e.g., “the airline may allow the residual value of the unused ticket to be applied to another flight”). It solves a problem where the traveler did not have access to information concerning the traveler's own canceled tickets.

US 2014/0164177 to Fraser et al. discloses systems and methods for transferring items with restricted transferability. If a transfer is authorized, the systems and methods present information about the item to others. Such information may be presented as part of a bidding interface or an advertising interface. Fraser's transfers are not permitted legally or practically for airline reservations (and similar nontransferable reservations). For example, for obvious safety, tracking, and other reasons, airline passengers are not permitted to transfer their tickets to other persons. US 2018/0260741 to Lamoureux et al. discloses systems, methods, and computer program products that coordinate operation of systems after a passenger travel-plan disruption occurs. Responsive to a transfer request being received that includes at least a portion of a new travel plan to replace a disrupted travel plan of multiple passengers, a travel-plan inventory system automatically updates computers based on the travel-plan disruption of each passenger and the new travel plan, and an associated reservation system automatically updates one or more reservation records to reflect an association between each passenger and the new travel plan. Thereafter, a ticketing system automatically performs a ticketing process for each interrupted traveler relative to the new travel plan, and a departure control system automatically transfers passenger data stored for each passenger associated with the disrupted travel plans of every other passenger record associated with a new travel plan.

US published application 2019/0236852 to Ito et al. discloses a program to use in an electronic ticketing system. An electronic ticket may be an electronic designated-seat ticket to which the designated seat is linked; and information of the designated seat may be displayed on an electronic ticket face, displayed on a display means after the electronic ticket is deleted, so as to be visually recognizable compared to the electronic ticket face displayed on the display means before the electronic ticket is deleted. A user terminal may include receiving means for receiving an instruction from outside the system to change the electronic ticket face. The face of the electronic ticket to be displayed on the display means may be changed upon condition the user terminal receives the instruction.

US published application 2019/0318276 to Rouveure discloses a system including a server that maintains data structures corresponding to a booking list and an ordered standby list. The booking list and the standby list have entries identifying at least one participant or item. The server receives input identifying a booking entry in the booking list to be canceled and, in response to receiving the input identifying the booking entry to be canceled in the booking list, removes a top entry from an ordered standby list and substitutes the canceled booking entry with the top entry removed from the standby list.

U.S. Pat. No. 10,366,373 to Denker et al. discloses a computer-based ticketing system designed to enable users to electronically transfer tickets to other users and obtain tickets from still other users. A first software module executing in a server is configured to cancel a first ticket for a first seat at a first event associated with a first user and issue a second ticket for the first seat to a second user at least partly in response to instructions from the first user sent from a first user terminal and instructions from the second user sent from a second user terminal. Travelers may book travel services with several service providers. For example, a traveler may select and book transportation to an airport with a ground services provider. Also, travelers may select and book air travel with an air travel services provider. In addition, each traveler may select and book lodging with an accommodation services provider. Moreover, each traveler may select and book sightseeing events with a sightseeing services provider. The travelers may even select and book certain restaurants with a food service provider. However, even when using systems designed to allow a traveler to select and book several service provider events simultaneously, conflicts between some booked services may pose problems to travelers. Denker does not (and cannot) provide a viable method for “transfers” or “reselling” of airline tickets or reservations from one traveler to another, which is strictly forbidden for safety and other reasons. Laws, restrictions, regulations, and other policies forbid air travelers and others to transfer or resell ATRs for safety and other reasons.

U.S. Pat. No. 11,668,575 to Reis et al. discloses a system and a method for managing a travel itinerary by determining potential pre-event triggering events, working with service providers to coördinate travel services selected and booked by a traveler. Also disclosed is a travel management system, receiving from a traveler an electronic itinerary specifying a plurality of events. Based on the itinerary, the travel management system analyzes each of the plural events and then determines “pre-event triggers” for each of the plural events. Data analysis by the travel management system calculates “trigger times” associated with each pre-event trigger. The travel management system transmits, at the trigger times, the pre-event triggers to event managers, to execute a function corresponding to each event.

Flight arrangements for a booked air traveler list at least one pre-selected air travel carrier, a day and time of departure for each pre-selected carrier, a passenger boarding location and passenger dis-embarkment location for each such carrier, and passenger seating arrangements (e.g., economy, business, 1^{st} class, or “open seating”) of the carrier.

In the airline industry, available seats are commonly referred to as “inventory” and seating may be assigned or may be “open” (meaning unassigned). The inventory of an airline is generally classified into service classes (e.g., economy, premium economy, first class, business) including fare classes, for which pricing and booking conditions may apply. Fare classes, often noted by a single letter code, are complex and generally vary from airline to airline. The meaning of such codes, often unknown by most passengers, are designed to convey certain information to airline staff. For instance, these codes may indicate that a ticket has been fully paid for, or was discounted or purchased through a loyalty scheme, and so forth. Further in this regard, a predetermined number of seats may not be available for “open sale,” but might be reserved, for example, for connecting flight passengers or loyalty-scheme passengers. Overbooking—a common airline practice—is an exception to inventory management. A core principle of inventory management is precision inventory control which is designed to keep a preselected number of seats available for different fare classes, by opening and closing individual fare classes for sale.

A global distribution system (“GDS”) is a computerized network system used by travel industry service providers (e.g., airlines, hotels, car rental agencies, and so forth), able to access real-time inventory (e.g., actual number of hotel rooms available, actual number of air travel seats including 1^{st} class, business, and economy seats available), including air travel itineraries, schedules, and other information of booked air travelers. GDS network systems treat air travel tickets and air travel vouchers essentially the same.

Details for booked air travelers stored on internet-accessible computer servers accessible via one or more global distribution systems (GDSs), include information about booked air travelers who have paid for air travel arrangements. Such information includes details of booked travelers who cannot make use of their pre-paid flight arrangements as well as booked air travelers who do not want to make use of their flight arrangements. Booked air travelers who have paid for future flight arrangements but who cannot use one or more flight arrangements include but are not limited to booked air travelers needing to re-schedule due to unforeseen circumstances involving their booked flight arrangements.

The term “Flight Manifest” shall be understood throughout this patent specification as referencing a list of passengers and air travel crew of a specified aircraft. A Flight Manifest is generated from information compiled before departure of the aircraft based upon an assortment of flight check-in information. Each Flight Manifest, the information of which is always confidentially and held to protect passenger privacy and safety, could be used by predetermined secure organizations and associated people having an interest in air-flight transport to ensure that listed passengers have, in fact, boarded and that cargo listed has, in fact, been placed on board and, in fact, continues to be on board on arrival at each destination. Air carriers must transmit passenger manifest information of aircraft on route to the United States no later than 15 minutes after take-off of each such aircraft.

When booked air travel customers need to cancel a reservation or make changes to one or more of their air travel reservations, they are often faced with limited options from commercial airlines. For example, a commercial airline may impose restrictions and penalties, depending on class of reservation purchased, in which case airline customers must pay additional fees to change one or more booked air travel reservations. Problems are more acute for non-refundable air travel reservations, where pre-booked air traveler customers learn of “no reimbursement” policies for booked reservations that are not used. Thus, non-transferable inventory (i.e., inventory which cannot be transferred to a different person once sold), like air travel inventory provided by airlines and issued as “tickets,” are consumer problems, given the risks and uncertainties life brings during days leading up to an air travel event. Air travelers unable to use their tickets for a flight face the risk of losing all their travel investment if their tickets are subject to non-refundable policies or restrictions. The rise of even stricter airline policies and restrictions when applied across different ticket classes continue to offer air travelers less flexibility, resulting in an increase in non-refundable tickets, and air travelers unable to obtain monetary refunds for unused air travel reservations. A few tickets with relatively fewer restrictions may be canceled in exchange for air credit, but these still face limitations, such as being valid exclusively with the same airline for a specified length of time (e.g., within one year). Air travelers who do not use air credit received for unused tickets within time periods, as listed in the airline policies, risk losing such air credit without receiving an alternative form of compensation.

Aviation law forbids the transfer of air travel tickets to another person after a ticket is purchased. In most situations, the purchase of airline tickets subjects the purchaser to restrictions designed to deprive the purchaser from receiving refunds for unused airline tickets. Although select unused tickets may have predetermined residual value qualifying as a voucher and serving as “air credits” these, too, are subject to airline restrictions (such as restricting flights to original carriers) and limitations (such as limiting to one year). Thus, air travelers or their air travel services must be vigilant booking future flights, so that air credits are applied to all such future flights whenever possible. Moreover, if the details associated with air credits are not available, a booking agent may need to access one of several global distribution systems (GDSs) for records of one or more tickets associated with the air credits; and, even if identifying information is available, finding that GDS and accessing the records from it can be tedious and time consuming. Even if records are located, rules and restrictions for unused tickets must be properly analyzed to determine residual value for a ticket, and whether that residual value can be applied to a new ticket.

When booked air travelers must change or cancel an existing air travel reservation, they face limited options from airlines including restrictions and penalties depending upon type of fare purchased, often involving additional expenses, including cancellation fees. This problem is particularly acute for the “non-refundable” travel ticketing-fare category, where air travel customers who choose not to pay high fees to be able change or cancel existing air travel reservations, don't receive refunds or reimbursement for unused tickets.

Currently, a refund or reimbursement for unused tickets is only available when an air traveler purchases a costly refundable ticket or may occasionally be available when extraordinary circumstances are presented such as a health issue or death in the family. An air travel form of “trip” insurance, not always available as an option, if available, must be paid for at the time of booking, and may include some limitations. Business meetings may take more time than anticipated, and other business opportunities may come to light.

However, all current business models for changing or canceling non-transferable air travel inventory linked to booked air travel reservations (i.e., air flight tickets bought for a named person) only benefit the airline industry and penalize air travel customers when customers cannot use their flights. When requesting a change of date or a change of departure time, fees for such changes may surpass an original cost of an original booking. Therefore, air travelers generally do not try to recover expenses relating to canceled ticket purchases. Often, travelers miss a flight without notifying an airline, leading to an unused air travel reservation, where a booking air traveler could have purchased that reservation. This is also a missed business opportunity for airlines seeking to manage inventory more efficiently and more profitably while offering their customers a favorable flight experience.

Since there is no current solution to a problem arising from a request by a booked air traveler for a monetary refund, partial or total, of a non-refundable ticket or voucher unused by a booked traveler, many booked travelers want a system or process, enabling them to cancel a non-transferable booked air travel reservation, still usable by a booking air traveler. The present invention solves this problem. It would be prudent for the airline industry to opt into my system and process to manage inventory efficiently. My system and process would lead to improved airline inventory reports about occupied percentage of seats, would add new revenue streams, and would improve air customer satisfaction.

### SUMMARY

This invention generates new inventory of air travel reservations for purchase for the benefit of consumers and the air travel industry. In certain embodiments, an air travel reservation system of the present subject matter comprises a digital platform system (“DPS”) operably connected, by a direct or a wireless connection, to at least one global distribution system (“GDS”) and to at least one personal computer (“PC”).

The digital platform system (“DPS”) of the present subject matter comprises a registered user memory bank, a registered user air travel reservation memory bank, a registered user air travel reservation cancellation queue storage register, and a new generated air travel inventory storage register. The air travel reservation memory bank is operatively connected to the registered user memory bank and is operably connected, by a direct or a wireless connection, to the at least one global distribution system. The air travel reservation memory bank comprises a booked air travel reservation register, and a booking air travel itinerary register. The cancellation queue storage register and the new generated air travel inventory storage register are operably connected to the air travel reservation memory bank and are operably connected, by a direct or a wireless connection, to the global distribution system.

The cancellation queue storage register is configured to store booked air travel reservations selected for cancellation. Certain information in the cancellation queue storage register is transferred to a new generated air travel inventory storage register configured to store that information. For example, certain booking information from the cancellation queue storage register is transferred to the new generated air travel inventory storage register without the personal identification information (e.g., name, address) of the person(s) that had booked the air travel reservations selected for cancellation. The digital platform system includes an itinerary-match register operatively connected to the air travel reservation memory bank and the new generated air travel inventory storage register. There is, however, no “transfer”, “exchange”, “rebooking”, or “resale” of tickets or reservations from one person to another with this invention, and thus this invention is also not an exchange, bidding interface, or other method or system of transfer of such tickets or reservations. Such transfers are strictly forbidden (e.g., they cannot be authorized) for safety and other reasons. Laws, restrictions, regulations, and other policies forbid air travelers and others to transfer or resell ATRs for safety and other reasons.

The digital platform system also includes an itinerary-match register operatively connected to at least the new generated air travel inventory storage register.

The itinerary-match register is used by this invention so that registered users of the digital platform system can effectively compare an itinerary in the booking air traveler itinerary register to a reservation in the new generated air travel inventory storage register using the systems and processes of this invention (without the users being aware of these underlying systems and processes). When there is a match and the booking air traveler decides to purchase an itinerary that matches one in the new generated air travel inventory storage register, then the booking air traveler may use a valid credit card to purchase the reservation in the new generated air travel inventory storage register by electronically transferring funds into the itinerary-match register. The itinerary-match register alone or in conjunction with other components is configured to hold transferred funds and check for fraud on the credit card used to pay. After checking for fraud on the credit card used to pay and finding none, a new reservation is issued in the name of the booking air traveler and the booked air travel reservation selected for cancellation in the cancellation queue storage register is canceled.

The itinerary-match register in certain embodiments is configured to apportion transferred funds used to purchase a reservation selected from the new generated air travel inventory storage register into a major portion to be paid to the registered user of the digital platform system for the cancelled air travel reservation and a minor portion that is used to fund the operation of the air travel reservation system.

Before being permitted to access the air travel reservation system, a user must be registered with the digital platform system (“DPS”). To register, a user must read the DPS protocols including but not limited to composing a username and a password to gain access to the air travel reservation system. Registered users must follow prompts to input air travel information including their booked reservations and their booking destinations (itineraries).

After registration with the digital platform system (“DPS”) is successful and a newly registered user accesses the DPS to book one or more air travel reservations, the newly registered DPS user may select at least one booked air travel reservation for cancellation.

Therefore, after newly registered users of the air travel reservation system of the present subject matter each transfer at least one prior-booked air travel reservation into the booked air travel reservation register, and after each newly registered user selects, for cancellation, an associated at least one prior-booked air travel reservation (stored in the air travel reservation register), then the air travel reservation, selected for cancellation, can be transferred, by operation of the components of the digital platform system (“DPS”), from the booked air travel reservation register into the cancellation queue storage register. Following that, certain of the information related to the air travel reservation stored in the cancellation queue storage register is then transferred to the new generated air travel inventory storage register.

The new generated air travel inventory storage register then generates a new inventory that contains the same information from the air travel reservation stored in the cancellation queue storage register (such as travel itinerary, schedules, departure and arrival ports, etc.), except for certain information pertaining to the registered user. This new generated air travel inventory will then become available in the system through the itinerary-match register.

After a newly registered or prior-registered user of the air travel reservation system finds and selects an itinerary suitable for their needs, the itinerary-match register is checked by the systems and processes of this invention to see if the selected itinerary matches any of the new generated inventory in the new generated air travel inventory storage register. If the registered user purchases the selected itinerary, and the itinerary-match register identifies the purchased itinerary to match one of the new generated inventory in the new generated air travel inventory storage register, then the associated air travel reservation in the cancellation queue storage registered is cancelled, and the registered user of the cancelled air travel reservation is eligible to receive a full or partial refund.

### BRIEF DESCRIPTION OF THE DRAWING FIGURES

FIG. 1 is a schematic drawing of the air travel reservation system of the present subject matter depicting, in schematic format, major operational components thereof.

FIG. 2 presents a schematic drawing of the digital platform system of the present subject matter depicting, in schematic format, major operational components thereof.

FIG. 3 is a schematic drawing of an illustrative commercial air travel reservation system and a data storage-and-transmission system including a digital platform system of the present subject matter, presenting certain operational components for each system.

FIG. 4 exemplifies an air travel reservation process for certain embodiments of the present subject matter.

Throughout the drawing figures and the detailed description, similar alphanumeric references shall be used to refer to features of the present subject matter that are similar.

### DETAILED DESCRIPTION

A global distribution system (“GDS”) is a computerized network system owned or operated by at least one person or business entity. A GDS is adapted and configured for enabling transactions between travel industry service providers, e.g., airlines, hotels, car rental companies, and travel agencies. GDS mainly uses real-time inventory (e.g., one or more “open” hotel rooms, one or more available flight seats, or cars) from assorted service providers. Travel agencies traditionally rely on a GDS (for services, products, and rates) to provide travel-related services to an assortment of travel consumers. GDS is this often used (linking services, rates, bookings) to offer products and services across three travel sectors: i.e., airline reservations, hotel reservations, car rentals. (Wikipedia.) For the travel sectors listed, the present subject matter is only directed to air travel reservation systems, in which a prior-registered user of the air travel reservation system disclosed herein seeks to cancel booked air travel reservations and receive a refund for cancelling reservations.

The term “passenger name record” (PNR) shall be understood throughout this patent specification as a record in the database of a computer reservation system (“CRS”) containing Air travel arrangements and associated travel-plan details including various routes to access destinations for a passenger or group of passengers travelling together. The concept of a PNR was introduced by airlines that needed to exchange reservation information (called “interlining”) in case passengers required flights of multiple airlines to reach their destination. When a passenger books a travel plan on a travel website, where the travel plan includes one or more Air travel arrangements, the travel website user will generate a PNR in the computer reservation system used to book the travel plan. Such a computer reservation system is often a large global distribution system (“GDS”), such as Amadeus, Sabre, or Travelport (doing business as Apollo, Galileo, and/or Wordspan). But if the booking is made directly with an airline, the PNR may also be in the database of the airline's CRS. Such a PNR is called the Master PNR for the passenger and associated travel-plan details. The PNR is identified in an associated database by a record locator.

When portions of a booked travel plan are not provided by a master PNR holder, then copies of the PNR information are sent to the CRSs of airlines able to provide transportation that will be providing transportation. These CRSs will open copies of the original PNR in their own database to manage the portion of the itinerary for which they are responsible. Many airlines have their CRS hosted by one of the GDSs, which allows sharing of the PNR. The record locators of the copied PNRs are communicated back to the CRS that owns the Master PNR, so that all records remain tied together. This allows exchanging updates of the PNR, when the status of the trip changes in any of the CRSs.

### Examples of a Booking Facilitation Done Via GDS by Several Commercial Airlines

A mirror image of a passenger name record (“PNR”) in the reservation system of several commercial airlines may be stored in a single global distribution system (“GDS”) system. If an airline passenger books an itinerary containing air segments of multiple airlines through a travel agency, a passenger name record in the GDS system noted would hold information of an entire itinerary, while each airline to be used would only have a portion of the itinerary relevant to each containing flight segments of their own services, but also including inbound and onward connecting flights of other airlines in the itinerary (called “info segments”). For instance, if a passenger books a journey from Amsterdam to London on KLM, London to New York on British Airways, and New York to Frankfurt on Lufthansa through a travel agent and if that travel agent is operatively connected to Amadeus GDS, the PNR in the Amadeus GDS would contain the full itinerary, while the PNR in the KLM system would show the Amsterdam to London segment along with the British Airways flight as an onward info segment. Moreover, the PNR in the Lufthansa system would show the New York to Frankfurt segment with the British Airways flight as an arrival information segment. Finally, the PNR in the British Airways system would show all three segments, one as a live segment and the other two as arrival and onward info segments. (Wikipedia.)

Digital platform systems are software-based online infrastructures that facilitate interactions and transactions between a variety of users. In addition, computing platforms, digital platforms, and software platforms are environments in which software programs might be executed by users. These platforms may include but not be limited to hardware, web browsers as well as their associated application programming interfaces, operating systems, and other underlying software, so long as a program code is also executed. (Id.)

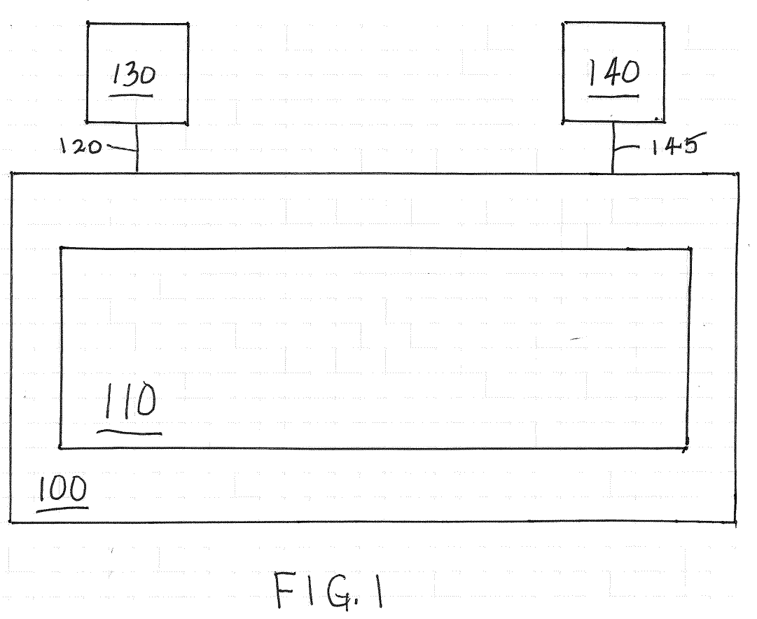

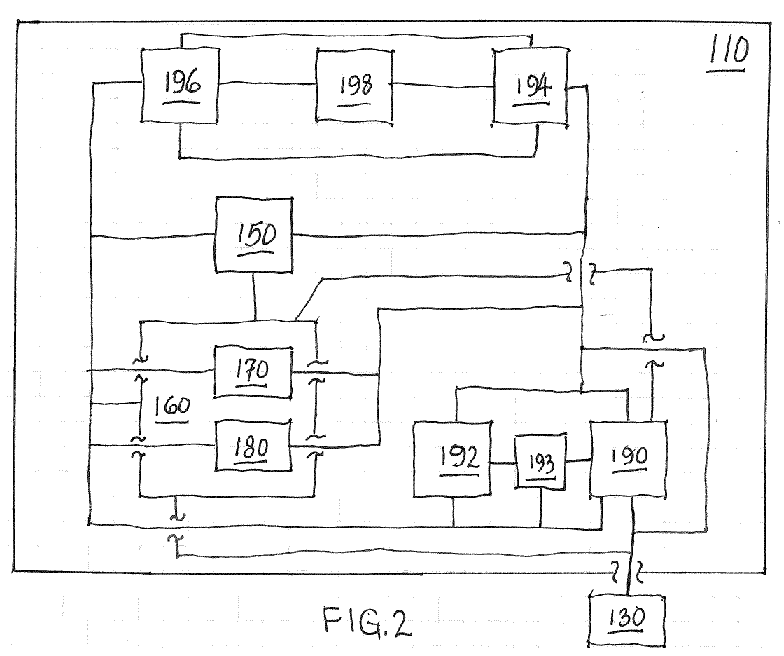

An air travel reservation system 100 (FIG. 1) comprises a digital platform system (“DPS”) 110 (FIG. 2) which includes a plurality of operatively interconnected components, wherein each component is adapted and configured to perform a predetermined function. The air travel reservation system (“ATRS”) 100 is operatively connected, by a direct or wireless connection 120, which is connected to the world wide web not shown, to at least one global distribution system (“GDS”) 130. At least one personal computer (“PC”) 140 is operatively connected, by another direct or wireless connection 145 (via the WWW), to the ATRS 100. For purposes of the present invention, a personal computer (“PC”) 140 shall be understood to include desktop and laptop computers (e.g., Apple, Dell, and the like) iPads, iPhones, and smartphones (made and sold worldwide, e.g., by Samsung).

The digital platform system (“DPS”) 110 (FIG. 2) comprises a system controller 194, at least one data processor 196 operatively connected to the system controller 194, and a power source 198 for the system controller 194 and the at least one data processor 196. The DPS 110 includes a registered user memory bank 150 operatively connected to the system controller 194 and to the at least one data processor 196, a registered user air travel reservation memory bank 160 operatively connected to the system controller 194 and to the at least one data processor 196, a registered user air travel reservation cancellation queue storage register 190 operatively connected to the system controller 194 and to the at least one data processor 196. The DPS 110 of the present invention includes a new generated air travel inventory storage register 192, and an itinerary-match register 193.

Registration: Each prospective user of the digital platform system 110 must register with the digital platform system 110 by creating a new user account in the registered user memory bank 150 as follows: After accessing the digital platform system 110 and entering all requested personal information (e.g., full legal name, address, system password, etc.) needed to make air travel reservations, a newly registered air traveler may use the air travel reservation system 100 and its digital platform system 110 to make a reservation.

The registered user air travel reservation memory bank 160 is operably connected, by a direct or a wireless connection, to the at least one global distribution system (“GDS”) 130. The registered user air travel reservation memory bank 160 comprises a booked air travel reservation register 170 and a booking air travel itinerary register 180. Each register 170, 180 is operatively connected to system controller 194 and the at least one data processor 196. The registered user cancellation queue storage register 190 is operably connected to the air travel reservation memory bank 160 via system controller 194 and the at least one data processor 196 and is separately operably connected, by a direct or a wireless connection, to the at least one global distribution system 130. The registered user cancellation queue storage register 190 is configured to store booked air travel reservations selected for cancellation. The new generated air travel inventory storage register 192 is operatively connected to the air travel reservation memory bank 190 and the air travel reservation cancellation queue storage register 190. The itinerary-match register 193 is operatively connected to the air travel reservation memory bank 160 and the new generated air travel inventory storage register 192. System controller 194 and the at least one data processor 196 are individually operatively connected to each of the following components: the registered user memory bank 150, the air travel reservation memory bank 160, the booked air travel reservation register 170, the booking air travel itinerary register 180, the air travel reservation cancellation queue 190, the new generated air travel inventory storage register 192, and the itinerary-match register 193. The at least one global distribution system 130 is also directly connected to air travel reservation memory bank 160, booked air travel reservation register 170, booking air travel itinerary register 180, air travel reservation cancellation queue storage register 190, the new generated air travel inventory storage register 192, the itinerary-match register 193, the DPS system controller 194, and the at least one data processor 196. The itinerary-match register 193 is used by the digital platform system (“DPS”) 110 and its processes to provide the capability to effectively compare an itinerary in the booking air travel itinerary register 180 to the inventory in the new generated air travel inventory storage register 192 (without the registered user being informed of how the components are operating to provide this capability). One of skill in the art will appreciate that the various registers and other components set forth herein are examples of performing the inventive operations of this application and different conformations are contemplated by and included in this invention to achieve the same results (e.g., by combining and/or separating various functions into different or the same registers and/or other components) and that they are operating in the background of what the registered user sees when the registered user is interacting with the digital platform system 110 and seeking travel reservations.

In certain embodiments, when a booking traveler wants to purchase a selected itinerary, the booking traveler may use a valid credit card. After processing payment, a new air travel reservation (and associated itinerary) is issued in the name of the booking traveler. If the itinerary-match register 193 identifies the purchased itinerary as a match to an itinerary from the new generated inventory in the new generated air travel inventory storage register 192, then the associated air travel reservation in the cancellation queue storage registered 190 is cancelled, and the registered user of the cancelled travel reservation is eligible to receive a full or partial refund.

In these embodiments, transferred funds from new reservations associated with inventory from the new generated air travel inventory storage register 192 are apportioned into a portion to be paid to the registered user of the digital platform system 110 for the air travel reservation canceled and another portion used to fund the operation of the air travel reservation system 100.

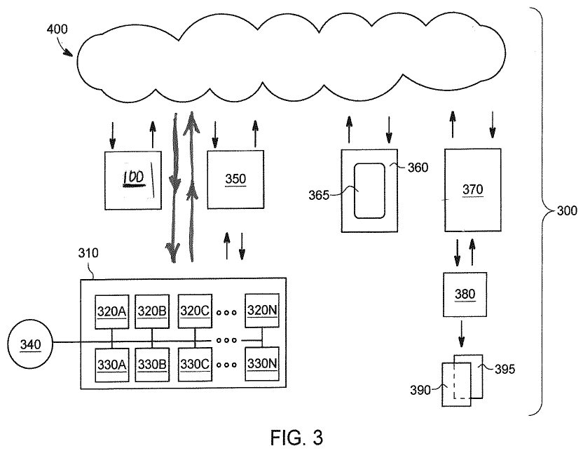

FIG. 3 is a schematic presentation of an illustrative data storage-and-transmission system 300 which includes the air travel reservation system 100 of the present invention.

The data storage-and-transmission system 300 includes data-input provisions 310 including a plurality of computers 320A, 320B, 320C, . . . and 320N and an associated plurality of user interfaces 330A, 330B, 330C, . . . and 330N, each of which is operably connected to an associated one of the plural computers 320A, 320B, 320C, . . . and 320N. Each computer also includes a program product comprising a machine-readable program code for causing, when executed, each computer to perform a series of programmed process steps. All, or a portion, of the programmed process steps may be predetermined or may be determined in real time, meaning “as the process steps are being performed.” A power source 340 (FIG. 3) provides power to each of the plural computers 320A, 320B, 320C, . . . and 320N, and to each of the plural interfaces 330A, 330B, 330C, . . . and 330N.

The data storage-and-transmission system 300 also includes the digital platform system 110 (see FIG. 2), at least one global distribution system (“GDS”) 350 operably connected to a plurality of commercial airlines, an electronic device 360, such as, an iPad device (sold by Apple), or an iPhone device (sold by Apple) or a commercial smartphone device (sold, e.g., by Samsung, Asus, Gionee, Google Pixel, and the like) equipped with a screen 365 configured to display one or more new Air travel reservations including one or more associated boarding passes. System 300 includes another electronic device 370 operably connected to a printer 380 equipped and configured to print one or more new air travel reservations 390 including associated boarding passes 395 on sheets of paper.

The data storage-and-transmission system 300 (FIG. 3) includes a cloud-based infrastructure 400 adapted and configured for data transmission and communication between the cloud-based infrastructure 400 and the at least one global distribution system 350 and associated data transmission and communication between each of the electronic devices 360, 370. When the digital platform system 110 is accessed by a user registered with the digital platform system 110, current information associated with registered users, stored in registered user memory bank 150 is accessible, as is current travel reservation information, stored in the air travel reservation memory bank 160; as is booked air traveler reservation information, stored in the booked reservation register 170; as is booking air traveler itinerary information, stored in the itinerary register 180, as are current air travel reservations, selected for cancellation in cancellation queue storage register 190.

In certain embodiments, the air travel reservation system (“ATRS”) 100 (FIG. 1) and the digital platform system (“DPS”) 110 (FIG. 2) may partially or totally use cloud-based data storage and/or cloud-based data analysis and processing and thus can be accessed and implemented in a distributed fashion using remotely located servers or other computers.

Servers, computers, and other devices described may be accessed by the internet. Cloud-based storage as well as data analysis and processing means may include online storage or processing means by which data is stored, analyzed and/or processed across a server or many interconnected servers, often hosted by a plurality of service providers. The term “cloud-based computing” system throughout this patent specification shall be understood to include one or more of cloud-based data storage units, one or more cloud-based data analysis and processing units, and one or more cloud-based data transfer units. Associated service providers may include one or more data center artificial intelligence (“AI”) units adapted and configured, or experienced human operators trained, to provide resources based on expressed customer necessities and other requirements.

The mobile devices also include communication provisions between the mobile device and one or more servers and between the mobile device and the registration and control component. Communication between the mobile device and a server can be established (or provided) by using one or more communication formats including radio frequency (RF), infrared (IR), and/or BLUETOOTH as known in the art. In embodiments, communication is by a wireless local area network (WLAN), i.e., Wi-Fi. Mobile devices may be communicatively coupled to cloud-based service and data centers including a third-party entity via, e.g., at least a wireless local area network technology (WLAN), i.e., Wi-Fi. However, embodiments of local access to cloud-based storage are not limited to wireless communications, and therefore hard-wired communications may also apply to the embodiments described herein. The mobile devices also include communication provisions between mobile devices and registration components and control components.

The data storage-and-transmission system 300 includes at least one global distribution system (GDS) 350 operably connected via a cloud-based infrastructure 400 (including, e.g., a computer server-farm based system) to the digital platform system 110.

The data storage-and-transmission system 300 includes a plurality of computers 320A, 320B, 320C, . . . 320N operatively connected to the at least one global distribution system (GDS) 350. In addition, each of the plural computers 320A, 320B, 320C, . . . 320N is operatively connected to an associated user interface 330A, 330B, 330C, . . . 330N.

The data storage-and-transmission system 300 includes a portable digital device 360 and a stationary digital device 370. The portable digital device 360 and the stationary digital device 370 are separately operatively connected by means of the cloud-based infrastructure 400 described above to the digital platform system 110. The portable digital device 360 includes a screen 365 on which an original or a new air travel reservation and its associated original or new ticket or voucher and its associated travel itinerary can be displayed. The stationary digital device 370 is operatively connected to at least one conventional printer 380. The printer 380 is configured to print impressions of the original ticket or voucher or the new ticket or voucher 390 and its associated travel itinerary 395.

The digital platform of the present subject matter benefits air travelers with existing reservations seeking to be refunded for their unused tickets and/or reservations. Also benefited are air travelers seeking to change travel plans, after making a reservation, by giving such air travelers options beyond standard airline options which may only include high change-of-flight fees, cancellation fees, or air-credit vouchers, usually only valid for one year, offering them an opportunity to be better compensated for unused reservations.

Currently, air travelers who need to cancel reservations or change itineraries have no choice but to pay high charges and cancellation fees imposed by airlines, which could exceed the price of original reservations. As a result, many air travelers opt to not show up to their flights and must then purchase new tickets. While this model has been giving airlines a great advantage for decades, limited options offered by airlines do not benefit their customers and have been creating a negative impact on air travelers in many ways.

The digital platform benefits air travelers looking for flexibility to change or cancel their existing reservations, if they discover that they may need to change their travel plans after booking a reservation. Instead of paying airlines fees and penalties, the model gives air travelers who want to change or cancel a reservation an opportunity to be reimbursed.

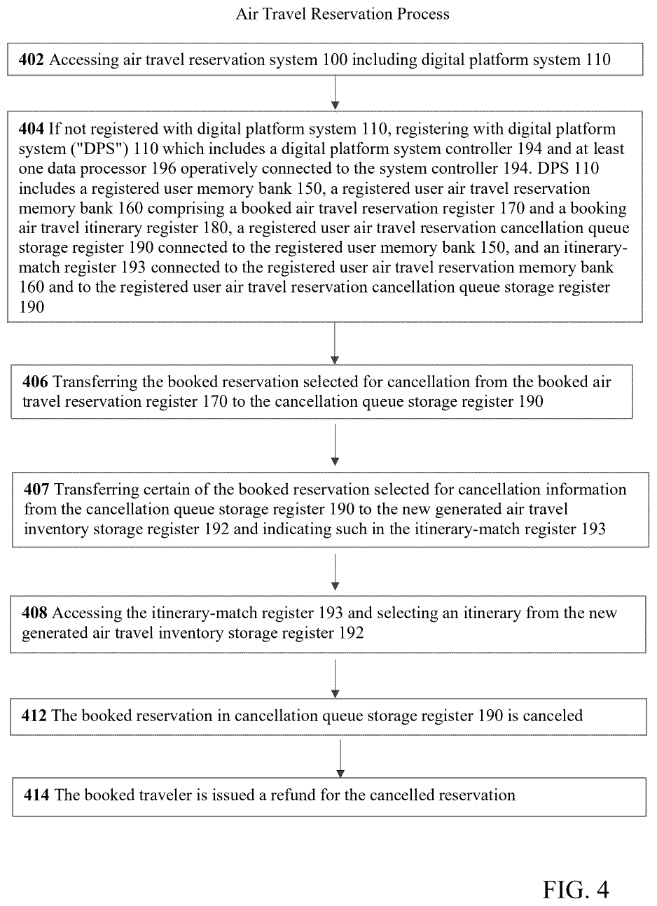

A process (FIG. 4) is configured either to issue a refund to an air traveler having a booked air travel reservation selected for cancellation or to generate a new air travel reservation for an air traveler seeking to book air travel to a predetermined destination.

A process (FIG. 4) for the present invention comprises several steps. It will be appreciated that these steps occur for the most part in the background by the actions of the components and are not known to the user. In addition, certain information concerning the travel reservations selected for cancellation are never revealed to the actual users, but instead are used in such background operations. A first step, 402, includes the components accessing an air travel reservation system 100. The air travel reservation system 100 includes a digital platform system 110. Another step, 404, if not yet registered with the digital platform system 110, includes registering with the digital platform system 110. The digital platform system 110 includes a system controller 194 and at least one data processor 196 operatively connected to the system controller 194. The digital platform system 110 includes as digital platform system components: a registered user memory bank 150, a registered user air travel reservation memory bank 160 comprising a booked air travel reservation register 170 and a booking air travel itinerary register 180, both registers 170 and 180 being connected to the registered user memory bank 150, a registered user air travel reservation cancellation queue storage register 190 connected to a new generated air travel inventory storage register 192 and the registered user memory bank 150, an itinerary-match register 193 connected to the registered user air travel reservation memory bank 160 and to the new generated air travel inventory storage register 192. In certain embodiments, the itinerary-match register 193 is operatively connected to the registered user memory bank 150, and one or more other components operatively connected to the user memory bank 150 in order to complete purchasing transactions. In embodiments of the present invention, the above-identified components are each operatively connected to system controller 194 and the at least one data processor 196.

For an air traveler having a booked air travel reservation selected for cancellation, other steps, 406 and 407, in the process include the components transferring information regarding the booked reservation selected for cancellation from the booked reservation register 170 to the cancellation queue storage register 190, and certain of the information concerning the booked reservation selected for cancellation in the cancellation queue storage register 190 is then transferred by the components to the new generated air travel inventory storage register 192 with the indicating of such in the itinerary-match register 193. The booked air travel reservation information selected for cancellation and transferred from the booked air travel reservation register 170 to the travel reservation cancellation queue storage register 190, is also transferred at least in part to the new generated air travel inventory storage register 192.

For the instance of where an air traveler seeking to book air travel to a predetermined destination by reviewing reservations selected for cancellation, the systems and processes of this invention (i.e., not necessarily the air traveler acting directly) applies another step, 408, which includes the components accessing the itinerary-match register 193 and reviewing the air travel reservation information selected from the new generated air travel inventory storage register 192. The itinerary-match register 193 is operatively connected by the system controller 194 and the at least one data processor 196 to the booking air traveler itinerary register 180 and to the new generated air travel inventory storage register 192. If the itinerary-match register 193 presents a match and a registered air traveler seeking to book air travel to a predetermined destination purchases the match, the booked reservation information in the cancellation queue storage register 190 is canceled, step 412, and the booked traveler is issued a refund, step 414, for the reservation selected for cancellation.

The booked traveler receiving a refund for an original cost of a reservation selected for cancellation, may receive the refund as a check delivered by the U.S. postal service, or by an electronic transfer of funds into a predetermined checking or savings account of a preselected bank or saving and loan, or by any mutually agreed to transfer procedure.

For registered users of the ATRS 100, a refund received for a reservation selected for cancellation, may range from various percentages.

Registered users of the air travel reservation system 100 of the present invention may access the digital platform system 110 by using a computer selected from a plurality of computers. For instance, the computer can be a desktop or a laptop computer, or the computer can be a so-called “smart” device, e.g., a tablet device or a smart phone device.

Furthermore, the air travel reservation system 100 of the present invention could be accessed by such devices as a mobile device having a network operatively connected to such connections as a cellular connection, a LAN connection, and a Wi-Fi connection.

Described in this patent specification and illustrated by its associated figures is an air travel reservation system and process, including a digital platform system as well as a data storage-and-transmission system. Also described in this specification are options for issuing an air traveler—having at least one booked air travel reservation selected for cancellation—a refund for any unused air travel reservations selected for cancellation. While described in relation to current embodiments, the scope of the present invention is not limited to the embodiments disclosed herein. Indeed, many alternatives, changes, and/or modifications will become apparent to a person of ordinary skill in the art (“POSITA”) after this patent specification and its figures are reviewed. Therefore, all such alternatives, changes, and modifications are to be viewed as forming a part of the present subject invention insofar as they fall within the spirit and scope of the appended claims.

Additional Examples. These examples are further directed to a problem in the airline industry that has never been solved before this invention. This invention generates new inventory (e.g., sets of information pertaining to reservations) of air travel reservations that was never before created. It benefits both consumers and the airline industry itself. For example, the airline industry has never had the cancellation queue storage register and the new generated air travel inventory storage register with the consumer interface and processes associated with them of this invention.

This new generated air travel inventory storage register creates a platform for the creation of anonymous, legitimate, real time, automated inventory of selected and air travel regulation compliant information that has never been collected, presented, searched, and sold before in this manner, which permits the generating of new inventory and revenue streams for purposes that have never been contemplated or provided for by the airline industry before. It also complies with applicable aviation laws, rules and regulations. This invention can be applied to other types of nontransferable reservations, such as those outside of the airline industry.

Certain embodiments of this invention provide potential significant benefits to consumers (e.g., disposing of cancelled reservations with less loss, purchasing previously unavailable reservations) and the airline industry itself (e.g., obtaining more information regarding consumers, better use of resources, obtaining higher consumer satisfaction) that they have never before thought of or implemented in this manner. It also creates a new industry that creates new air travel reservation inventory and manages such with a new generated air travel inventory storage register and the associated processes of the register. It should be noted that the new generated air travel inventory storage register availability can be provided in separate systems or be seamlessly incorporated into existing airline and other travel reservation systems.

These embodiments are directed to the generation of new inventory of air travel reservations. In certain of these embodiments, a new generated air travel inventory storage register is used that collects, stores, and thereby generates new inventory of air travel reservation information. In some embodiments the passenger or agent that booked the original air travel reservations indicates the desire to try to obtain compensation relating to the cancellation. Certain reservation information (itinerary, schedules, departure and arrival times, ports, etc.—excluding any personal passenger information) concerning this new inventory resulting from cancelled air travel reservations can then be displayed, accessed, searched, and sold, to a new consumer, which has never been done before.

Specifically, in certain of these embodiments a cancellation queue storage register or another such collection method is provided that is used with other components of this invention to generate new inventory from the collection and storage of booked air travel reservations that have been selected for cancellation by transferring selected reservation information to a new generated air travel inventory storage register. This new inventory can be displayed to and accessed (e.g., via an interface) and searched by a consumer, and the consumer can purchase the new inventory in an air travel regulation compliant process where the previous booked passenger remains anonymous.

In certain embodiments, an anonymous, real time, automated new generated air travel inventory storage register is provided. This comprises: (a) a new generated air travel inventory storage register that collects, stores, and permits access to an automatically generated inventory of air travel reservations in real time without revealing the identity of the purchasers or agents that booked the original reservations; (b) an interface to the new generated air travel inventory storage register that provides for searching of its contents; (c) a consumer interface (e.g., GUI) to the new generated air travel inventory storage register that provides for the display, searching and purchase of the inventory by consumers; and (d) wherein when the inventory is purchased by consumers, it is removed from the new generated air travel inventory storage register and the purchasers or agents that booked the original cancelled reservations are issued at least partial compensation. Information concerning the inventory can then be provided to airlines for their edification and use.

In addition, methods of generating new inventory of air travel reservations are provided. Certain of these methods comprise providing anonymous, real time, and automated new generated air travel inventory. These real time and automated methods can neither be done by humans or current computer systems. These methods may comprise: (a) collecting, storing, displaying, and/or permitting access to a new generated air travel inventory storage register that collects, stores, and permits display and/or access to an automatically generated inventory of reservation information to consumers in real time without revealing the identity of the purchasers or agents that booked the original reservations; (b) the providing of access, such as the display, searching and then potential purchasing of the inventory by the consumers; (c) the matching of a purchase request by the consumers to the inventory in the new generated air travel inventory storage register; (d) the removing from the inventory of the new generated air travel inventory storage register of any purchased inventory; and (e) issuing at least partial compensation to the purchasers or agents of the original cancelled reservations. In addition, the methods can include transferring information concerning the inventory to airlines for their edification and use.

Embodiments of this invention address the technical problem of obtaining value from reservation cancellations through a specific computer system architecture that has never been done before. No one was able to address the legal and practical barriers to the forbidden transfer of airline reservations from one person to another. The system comprises specific technical components including a digital platform system operably connected via internet to a global distribution system, specialized memory banks with distinct registers, and a sophisticated cancellation queue system. This is not merely organizing human activities or mental processes, but rather a technical solution requiring specific computer system interactions that cannot be performed by a human being. For example, a human being could not perform the methods and obtain the results of this invention automatically and in real time as required to provide the capability needed for real-world application, especially since the information must be processed anonymously and thus it cannot be done by hand.

The embodiments of this invention recite specific technical improvements including: (1) a new generated air travel inventory storage register that holds reservations for potential sale, (2) automated, real time, anonymous, transfer mechanisms of certain information between different registers, and (3) functionality that prevents the transfer of personal information and the otherwise loss of all value from canceled reservations. These elements provide an inventive concept that provides completely new opportunities and computer functionality in the air travel field.

I Claim:

1. An air travel reservation process comprising:
accessing an air travel reservation system (100), wherein the air travel reservation system includes a digital platform system (110), wherein a user is not permitted to access registered user air travel information contained within the digital platform system (110) until after being registered with the digital platform system (110);
if not registered with the digital platform system (110), registering with the digital platform system (110), wherein the digital platform system (110) includes a system controller (194) and at least one data processor (196) operatively connected to the system controller (194), wherein the digital platform system (110) also includes as components: a registered user memory bank (150), a registered user air travel reservation memory bank (160) comprising a booked air travel reservation register (170) and a booking air travel itinerary register (180) connected to the registered user memory bank (150), a registered user air travel reservation cancellation queue storage register (190) connected to the registered user travel reservation memory bank (160) and a new generated air travel inventory storage register (192), an itinerary-match register (193) connected to the booking air travel itinerary register (180) and the new generated air travel inventory storage register (192), wherein each of the components is operatively connected to the system controller (194) and the at least one data processor (196);
for the instance of an air traveler having a booked air travel reservation selected for cancellation, the process transfers information concerning the booked reservation selected for cancellation from the booked reservation register (170) to the air travel reservation cancellation queue storage register (190) and then the new generated air travel inventory storage register (192) and indicates, in the itinerary-match register (193), the booked air travel reservation selected for cancellation and transferred from the booked air travel reservation register (170) to the new generated air travel inventory storage register (192);
for the instance of an air traveler seeking to book air travel to at least one predetermined itinerary, the process accesses the itinerary-match register (193) and reviews the air travel reservations selected from the new generated air travel inventory storage register (192);
if the itinerary-match register (193) presents a match and a registered air traveler seeking to book air travel to the at least one predetermined itinerary purchases the match presented, the process accesses the booked air travel reservation contained within the new generated air travel inventory storage register (192) and cancels it; and
issuing a refund to the booked traveler for the air travel reservation that was canceled.

2. The air travel reservation process of claim 1, including, if not registered with the digital platform system (110), registering with the digital platform system (110), in order to be able to use the digital platform system.

3. The air travel reservation process of claim 1, wherein the air travel reservation system (100) is accessed by using a computer (140) selected from a plurality of computers.

4. The air travel reservation process of claim 1, wherein the air travel reservation system (100) is accessed by using a computer (140) selected from the group consisting of a desktop computer, a laptop computer, a tablet device, and a smart phone device.

5. The air travel reservation process of claim 1, wherein a refund issued to the booked traveler for the air travel reservation selected for cancellation ranges from 70% to 90% of a cost of a reservation selected from the cancellation queue storage register (190).

6. The air travel reservation process of claim 5, wherein a full or partial refund is issued to the booked traveler.

7. An air travel reservation system (100) comprising a digital platform system (110), wherein the air travel reservation system (100) is operatively connected to at least one global distribution system (130) and to at least one personal computer (140), wherein the digital platform system (110) comprises:
a system controller (194);
at least one data processor (196) operatively connected to the system controller;
a registered user memory bank (150) operatively connected to the system controller (194) and to the at least one data processor (196);
a registered user air travel reservation memory bank (160) operatively connected by the system controller (194) and the at least one data processor (196) to the registered user memory bank (150) and to the at least one global distribution system (130), wherein the registered user air travel reservation memory bank (160) comprises: a booked air travel reservation register (170), and a booking air travel itinerary register (180);
a registered user air travel reservation cancellation queue storage register (190) operatively connected by the system controller (194) and the at least one data processor (196) to the at least one global distribution system (130) and to the air travel reservation memory bank (160), wherein the registered user air travel reservation cancellation queue storage register (190) contains at least one booked air travel reservation selected by a registered user for cancellation;
a new generated air travel inventory storage register (192) operatively connected to the registered user air travel reservation cancellation queue storage register (190);
an itinerary-match register (193) operatively connected by the system controller (194) and the at least one data processor (196) to the registered user air travel reservation memory bank (160), wherein the itinerary-match register (193) is adapted and configured for storing at least one booked air travel reservation selected for cancellation by a registered user and stored in the new generated air travel inventory storage register (192); and
the itinerary-match register (193) operatively connected by the system controller (194) and the at least one data processor (196) to the new generated air travel inventory storage register (192),
wherein, if the itinerary-match register (193) presents a match and a registered air traveler seeking to book air travel to at least one predetermined destination accesses the itinerary-match register (193) and purchases the match presented, the inventory contained within the new generated air travel inventory storage register (192) is canceled, a new air travel reservation is issued to the registered air traveler seeking to book air travel to the at least one predetermined destination, and the registered air travel whose booked air travel reservation contained the cancellation queue storage register (190) was canceled is issued compensation for the booked air travel reservation canceled from the cancellation queue storage register (190).

8. The air travel reservation system (100) of claim 7, wherein the at least one personal computer (140) comprises one or more computers selected from the group consisting at least one desktop computer, at least one laptop computer, and combinations thereof.

9. The air travel reservation system (100) of claim 7, wherein the at least one personal computer (140) comprises one or more computers selected from the group consisting of at least one iPad, at least one iPhone or smartphone, and combinations thereof.

10. The air travel reservation system (100) of claim 7, wherein a refund is issued to the booked traveler for the air travel reservation selected for cancellation.

11. The air travel reservation system (100) of claim 10, wherein a full or partial refund is issued to the booked traveler.

12. A data storage-and-transmission system (300) operatively connected to a cloud-based infrastructure (400), wherein the data storage-and-transmission system (300) comprises:
data-input provisions (310) operatively connected to the cloud-based infrastructure (400), wherein the data-input provisions (310) include a plurality of computers (320A, 320B, 320C, . . . and 320N) and an associated plurality of user interfaces (330A, 330B, 330C, . . . and 330N), wherein each interface is operably connected to an associated one of the plural computers (320A, 320B, 320C . . . and 320N);
an air travel reservation system (100) comprising:
a digital platform system (110) operatively connected by the cloud-based infrastructure (400) to at least one global distribution system (350) and to the data-input provisions (310), the digital platform system (110) comprising:
a system controller (194);
at least one data processor (196) operatively connected to the system controller (194);
a registered user memory bank (150) operatively connected to the system controller (194) and to the at least one data processor (196);
a registered user air travel reservation memory bank (160) operatively connected by the system controller (194), to the at least one data processor (196), the registered user memory bank (150), and the at least one global distribution system, wherein the registered user travel reservation memory bank (160) includes a booked air travel reservation register (170) and a booking air travel itinerary register (180);
a registered user air travel reservation cancellation queue storage register (190) operatively connected by the system controller (194) and the at least one data processor (196) to the at least one global distribution system (350) and to the air travel reservation memory bank (160), wherein the registered user air travel reservation cancellation queue storage register (190) contains at least one booked air travel reservation selected by a registered user for cancellation;
a new generated air travel inventory storage register (192) operatively connected to the registered user air travel reservation cancellation queue storage register (190);
an itinerary-match register (193) operatively connected by the system controller (194) and the at least one data processor (196) to the registered user air travel reservation memory bank (160), wherein the itinerary-match register (193) is adapted and configured for storing inventory from the new generated air travel inventory storage register (192); and
wherein, If the system determines that an air travel reservation purchased by the registered air traveler matches inventory in the itinerary-match register (193), the system accesses the booked air travel reservation contained within the new generated air travel reservation storage register (192) and cancels it, a new air travel reservation is issued to the registered air traveler seeking to book air travel to the at least one predetermined destination, and the registered air travel whose booked air travel reservation contained the cancellation queue storage register (190) was canceled is issued a refund for the booked air travel reservation canceled from the cancellation queue storage register (190).

13. The data storage-and-transmission system (300) of claim 12, including a portable digital device (360) having a screen (365), wherein the portable digital device (360) is operatively connected by the cloud-based infrastructure (400) to the digital platform system (110).

14. The data storage-and-transmission system (300) of claim 12, including a stationary digital device (370) and a printer (380) operatively connected to the stationary digital device, wherein the stationary digital device (370) is operatively connected by the cloud-based infrastructure (400) to the digital platform system (110).

15. The data storage-and-transmission system (300) of claim 12, wherein a full or partial refund issued to the booked traveler for the air travel reservation selected for cancellation.

16. A real time, automated inventory system of air travel reservation information for reservations that were cancelled by purchasers or agents that booked the cancelled air travel reservations, the inventory system comprising:
(a) a new generated air travel inventory storage register that collects, stores, and permits access to air travel reservations to be cancelled, in real time, without revealing the identity of the purchasers or agents that booked the original air travel reservations to be cancelled, and automatically generates inventory that matches the itinerary of the air travel reservations to be cancelled;
(b) an interface to the new generated air travel inventory storage register that provides for searching of the new generated inventory;
(c) a graphical user interface that displays the new generated inventory and allows the consumers to purchase the new generated inventory; and
(d)wherein when the new generated inventory is purchased by the consumers, the air travel reservations to be cancelled are effectively cancelled and removed from the cancellation queue storage register, and the purchasers or agents that booked the original air travel reservations are issued at least partial compensation for the cancelled air travel reservations.

17. A method of generating inventory of anonymous, real time, and automated air travel reservation information pertaining to reservations that were cancelled by original purchasers or agents that booked the reservations, the method comprising:
(a) collecting, storing, and permitting access to a new generated air travel inventory storage register that collects, stores, and permits access to an automatically generated inventory of air travel reservations in real time without revealing information associated with the original purchasers or agents that booked the reservations;
(b) providing access to the inventory stored in the new generated air travel inventory storage register thereby providing new inventory options available for purchase in response to a new purchase request by a user;
(c)matching the new purchase request to inventory in the new generated air travel inventory storage register;
(d) removing the air travel reservations to be cancelled in the cancellation queue storage register after the user purchases a new generated inventory that matched the itinerary of the air travel reservation to be cancelled in the cancellation queue; and
(e) issuing at least partial compensation to the original purchasers or agents of the cancelled reservations.
